(19) United States
(12) Patent Application Publication
(10) Pub. No.: US 2021/0190057 A1
(43) Pub. Date: Jun. 24, 2021

(54) CRYOPUMP AND CRYOPANEL

(71) Applicant: SUMITOMO HEAVY INDUSTRIES, LTD., Tokyo (JP)

(72) Inventor: Kakeru Takahashi, Tokyo (JP)

(21) Appl. No.: 17/193,682

(22) Filed: Mar. 5, 2021

Related U.S. Application Data
(63) Continuation of application No. PCT/JP2019/030302, filed on Aug. 1, 2019.

(30) Foreign Application Priority Data
Sep. 6, 2018 (JP) 2018-167177

(51) Int. Cl. F04B 37/08

(52) U.S. Cl. CPC F04B 37/08

(57) ABSTRACT

A cryopump includes a cryopanel assembly which includes an exposed area that a gas to be pumped can linearly reach through a cryopump intake port and a non-exposed area that the gas to be pumped cannot linearly reach through the cryopump intake port, in which the non-exposed area has an adsorption area capable of adsorbing a non-condensable gas, and the exposed area is covered with a removable protective surface.

### RELATED APPLICATIONS

The contents of Japanese Patent Application No. 2018-167177, and of International Patent Application No. PCT/JP2019/030302, on the basis of each of which priority benefits are claimed in an accompanying application data sheet, are in their entirety incorporated herein by reference.

### BACKGROUND

### Technical Field

Certain embodiments of the present invention relate to a cryopump and a cryopanel.

### Description of Related Art

A cryopump is a vacuum pump which captures gas molecules on a cryopanel cooled to a cryogenic temperature by condensation or adsorption to pump the gas molecules. The cryopump is generally used to realize a clean vacuum environment which is required for a semiconductor circuit manufacturing process or the like. Since the cryopump is a so-called gas accumulation type vacuum pump, regeneration to periodically discharge the captured gas to the outside is required.

### SUMMARY

According to an embodiment of the present invention, there is provided a cryopump including: a cryopanel assembly which includes an exposed area that a gas to be pumped can linearly reach through a cryopump intake port and a non-exposed area that the gas to be pumped cannot linearly reach through the cryopump intake port. The non-exposed area has an adsorption area capable of adsorbing a non-condensable gas, and the exposed area is covered with a removable protective surface.

According to another embodiment of the present invention, there is provided a cryopanel including: a cryopanel base material; and a removable protective surface that covers at least a part of the cryopanel base material.

### BRIEF DESCRIPTION OF THE DRAWINGS

FIG. 1 schematically shows a cryopump according to a certain embodiment.

FIG. 2 is a schematic perspective view of an exemplary cryopanel that can be used in the cryopump shown in FIG. 1.

FIG. 3 is a schematic perspective view of another exemplary cryopanel that can be used in the cryopump shown in FIG. 1.

FIG. 4 is a schematic top view of still another exemplary cryopanel that can be used in the cryopump shown in FIG. 1.

### DETAILED DESCRIPTION

Depending on a use of the cryopump, during an evacuation operation, a certain kind of gas that is not easily discharged even if regeneration is performed flows into the cryopump and condenses on and adheres to a cryopanel, and thus the cryopanel can be contaminated with such deposits. The contaminated cryopanel may need to be disassembled from the cryopump and washed during maintenance of the cryopump. The washed cryopanel is reassembled and used in a case where it is reusable. In a case where it cannot be reused, it is discarded and replaced with a new cryopanel. In any case, such maintenance is troublesome.

It is desirable to facilitate maintenance of a cryopump.

Any combination of the constituent elements described above, or replacement of constituent elements or expressions of the present invention with each other between methods, apparatuses, systems, or the like is also valid as an aspect of the present invention.

Hereinafter, modes for carrying out the present invention will be described in detail with reference to the drawings. In the description and the drawings, identical or equivalent constituent elements, members, and processing are denoted by the same reference numerals, and overlapping description is omitted appropriately. The scales or shapes of the respective parts shown in the drawings are set for convenience in order to facilitate description and are not interpreted to a limited extent unless otherwise specified. Embodiments are exemplification and do not limit the scope of the present invention. All features described in the embodiments or combinations thereof are not necessarily essential to the invention.

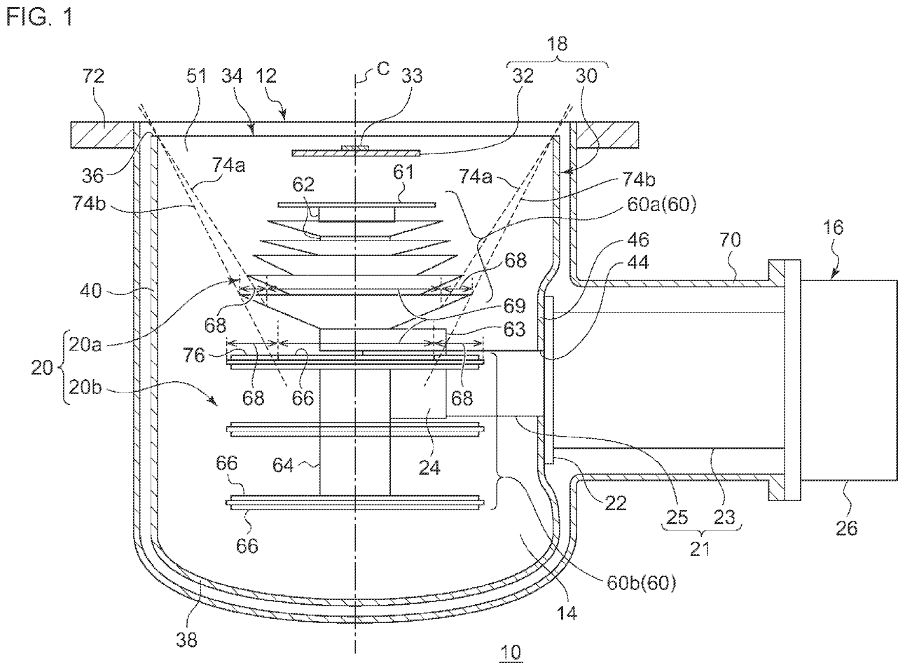

FIG. 1 schematically shows a cryopump 10 according to a certain embodiment.

The cryopump 10 is mounted to a vacuum chamber of, for example, an ion implanter, a sputtering apparatus, a vapor deposition apparatus, or other vacuum process equipment and is used to increase the degree of vacuum in the interior of the vacuum chamber to a level which is required for a desired vacuum process. The cryopump 10 has a cryopump intake port (hereinafter, also simply referred to as an “intake port”) 12 for receiving a gas to be pumped, from the vacuum chamber. The gas enters an internal space 14 of the cryopump 10 through the intake port 12.

In the following, there is a case where the terms “axial direction” and “radial direction” are used in order to express the positional relationship between constituent elements of the cryopump 10 in an easily understandable manner. The axial direction of the cryopump 10 represents a direction passing through the intake port 12 (that is, a direction along a central axis C in the drawing), and the radial direction represents a direction along the intake port 12 (a first direction in the plane perpendicular to the central axis C). For convenience, with respect to the axial direction, there is a case where the side relatively close to the intake port 12 is referred to as an “upper side” and the side relatively distant from the intake port 12 is referred to as a “lower side”. That is, there is a case where the side relatively distant from the bottom of the cryopump 10 is referred to as an “upper side” and the side relatively close to the bottom of the cryopump 10 is referred to as a “lower side”. With respect to the radial direction, there is a case where the side close to the center (in the drawing, the central axis C) of the intake port 12 is referred to as an “inner side” and the side close to the peripheral edge of the intake port 12 is referred to as an “outer side”. Such expressions are not related to the disposition when the cryopump 10 is mounted to the vacuum chamber. For example, the cryopump 10 may be mounted to the vacuum chamber with the intake port 12 facing downward in the vertical direction.

Further, there is a case where a direction surrounding the axial direction is referred to as a “circumferential direction”. The circumferential direction is a second direction along the intake port 12 (a second direction in the plane perpendicular to the central axis C) and is a tangential direction orthogonal to the radial direction.

The cryopump 10 includes a cryocooler 16, a first-stage cryopanel 18, a second-stage cryopanel assembly 20, and a cryopump housing 70. The first-stage cryopanel 18 may be referred to as a high-temperature cryopanel part or a 100 K part. The second-stage cryopanel assembly 20 may be referred to as a low-temperature cryopanel part or a 10 K part.

The cryocooler 16 is a cryocooler such as a Gifford McMahon type cryocooler (a so-called GM cryocooler), for example. The cryocooler 16 is a two-stage cryocooler. Therefore, the cryocooler 16 includes a first cooling stage 22 and a second cooling stage 24. The cryocooler 16 is configured to cool the first cooling stage 22 to a first cooling temperature and cool the second cooling stage 24 to a second cooling temperature. The second cooling temperature is lower than the first cooling temperature. For example, the first cooling stage 22 is cooled to a temperature in a range of about 65 K to 120 K, preferably, in a range of 80 K to 100 K, and the second cooling stage 24 is cooled to a temperature in a range of about 10 K to 20 K. The first cooling stage 22 and the second cooling stage 24 may be referred to as a high-temperature cooling stage and a low-temperature cooling stage, respectively.

Further, the cryocooler 16 includes a cryocooler structure part 21 that structurally supports the second cooling stage 24 on the first cooling stage 22 and structurally supports the first cooling stage 22 on a room temperature part 26 of the cryocooler 16. Therefore, the cryocooler structure part 21 includes a first cylinder 23 and a second cylinder 25 that extend coaxially along the radial direction. The first cylinder 23 connects the room temperature part 26 of the cryocooler 16 to the first cooling stage 22. The second cylinder 25 connects the first cooling stage 22 to the second cooling stage 24. The room temperature part 26, the first cylinder 23, the first cooling stage 22, the second cylinder 25, and the second cooling stage 24 are linearly arranged in this order.

A first displacer and a second displacer (not shown) are reciprocally disposed in the interiors of the first cylinder 23 and the second cylinder 25, respectively. A first regenerator and a second regenerator (not shown) are respectively incorporated into the first displacer and the second displacer. Further, the room temperature part 26 has a drive mechanism (not shown) for reciprocating the first displacer and the second displacer. The drive mechanism includes a flow path switching mechanism that switches a flow path of a working gas (for example, helium) so as to periodically repeat the supply and discharge of the working gas to and from the interior of the cryocooler 16.

The cryocooler 16 is connected to a compressor (not shown) for the working gas. The cryocooler 16 cools the first cooling stage 22 and the second cooling stage 24 by expanding the working gas pressurized by the compressor in the interior thereof. The expanded working gas is recovered to the compressor and pressurized again. The cryocooler 16 generates cold by repeating a thermodynamic cycle (for example, a refrigeration cycle such as a GM cycle) including the supply and discharge of the working gas and the reciprocation of the first displacer and the second displacer in synchronization with the supply and discharge of the working gas.

The cryopump 10 which is shown in the drawing is a so-called horizontal cryopump. The horizontal cryopump is generally a cryopump in which the cryocooler 16 is disposed so as to intersect (usually, be orthogonal to) the central axis C of the cryopump 10.

The first-stage cryopanel 18 includes a radiation shield 30 and an inlet cryopanel 32 and surrounds the second-stage cryopanel assembly 20. The first-stage cryopanel 18 provides a cryogenic surface for protecting the second-stage cryopanel assembly 20 from radiant heat outside the cryopump 10 or from the cryopump housing 70. The first-stage cryopanel 18 is thermally coupled to the first cooling stage 22. Accordingly, the first-stage cryopanel 18 is cooled to the first cooling temperature. The first-stage cryopanel 18 has a gap between itself and the second-stage cryopanel assembly 20, and the first-stage cryopanel 18 is not in contact with the second-stage cryopanel assembly 20. The first-stage cryopanel 18 is also not in contact with the cryopump housing 70.

The radiation shield 30 is provided to protect the second-stage cryopanel assembly 20 from the radiant heat of the cryopump housing 70. The radiation shield 30 extends in a tubular shape (for example, a cylindrical shape) in the axial direction from the intake port 12. The radiation shield 30 is located between the cryopump housing 70 and the second-stage cryopanel assembly 20 and surrounds the second-stage cryopanel assembly 20. The radiation shield 30 has a shield main opening 34 for receiving gas from the outside of the cryopump 10 into the internal space 14. The shield main opening 34 is located at the intake port 12.

The radiation shield 30 is provided with a shield front end 36 defining the shield main opening 34, a shield bottom portion 38 which is located on the side opposite to the shield main opening 34, and a shield side portion 40 connecting the shield front end 36 to the shield bottom portion 38. The shield side portion 40 extends in the axial direction from the shield front end 36 to the side opposite to the shield main opening 34, and extends so as to surround the second cooling stage 24 in the circumferential direction.

The shield side portion 40 has a shield side portion opening 44 into which the cryocooler structure part 21 is inserted. The second cooling stage 24 and the second cylinder 25 are inserted into the radiation shield 30 from outside the radiation shield 30 through the shield side portion opening 44. The shield side portion opening 44 is a mounting hole formed in the shield side portion 40 and is, for example, circular. The first cooling stage 22 is disposed outside the radiation shield 30.

The shield side portion 40 is provided with a mounting seat 46 for the cryocooler 16. The mounting seat 46 is a flat portion for mounting the first cooling stage 22 to the radiation shield 30, and is slightly depressed when viewed from outside the radiation shield 30. The mounting seat 46 forms the outer periphery of the shield side portion opening 44. The first cooling stage 22 is mounted to the mounting seat 46, whereby the radiation shield 30 is thermally coupled to the first cooling stage 22.

Instead of directly mounting the radiation shield 30 to the first cooling stage 22 in this manner, in an embodiment, the radiation shield 30 may be thermally coupled to the first cooling stage 22 through an additional heat transfer member. The heat transfer member may be, for example, a hollow short cylinder having flanges at both ends. The heat transfer member may be fixed to the mounting seat 46 by the flange at one end and fixed to the first cooling stage 22 by the flange at the other end. The heat transfer member may extend from the first cooling stage 22 to the radiation shield 30 to surround the cryocooler structure part 21. The shield side portion 40 may include such a heat transfer member.

In the illustrated embodiment, the radiation shield 30 is configured in an integral tubular shape. Instead, the radiation shield 30 may be configured to have a tubular shape as a whole by a plurality of parts. The plurality of parts may be disposed with a gap therebetween. For example, the radiation shield 30 may be divided into two parts in the axial direction.

The inlet cryopanel 32 is provided at the intake port 12 (or the shield main opening 34, the same applies hereinafter) in order to protect the second-stage cryopanel assembly 20 from the radiant heat from a heat source outside the cryopump 10 (for example, a heat source in the vacuum chamber to which the cryopump 10 is mounted). Further, gas (for example, moisture) condensing at the cooling temperature of the inlet cryopanel 32 is captured on the surface thereof.

The inlet cryopanel 32 is disposed at a location corresponding to the second-stage cryopanel assembly 20 at the intake port 12. The inlet cryopanel 32 occupies the central portion of the opening area of the intake port 12, and forms an annular (for example, circular ring-shaped) open area 51 between itself and the radiation shield 30. The shape of the inlet cryopanel 32 when viewed in the axial direction is, for example, a disk shape. The diameter of the inlet cryopanel 32 is relatively small and is smaller than the diameter of the second-stage cryopanel assembly 20, for example. The inlet cryopanel 32 may occupy at most ⅓ or at most ¼ of the opening area of the intake port 12. In this way, the open area 51 may occupy at least ⅔ or at least ¾ of the opening area of the intake port 12.

The inlet cryopanel 32 is mounted to the shield front end 36 through an inlet cryopanel mounting member 33. As shown in FIG. 1, the inlet cryopanel mounting member 33 is a linear member that extends over the shield front end 36 along the diameter of the shield main opening 34. In this manner, the inlet cryopanel 32 is fixed to the radiation shield 30 and is thermally coupled to the radiation shield 30. The inlet cryopanel 32 is adjacent to, but not in contact with, the second-stage cryopanel assembly 20. Further, the inlet cryopanel mounting member 33 divides the open area 51 in the circumferential direction. The open area 51 is composed of a plurality of (for example, two) arc-shaped areas. The inlet cryopanel mounting member 33 may have a cross shape or another shape.

The inlet cryopanel 32 is disposed at the central portion of the intake port 12. The center of the inlet cryopanel 32 is located on the central axis C. However, the center of the inlet cryopanel 32 may be located somewhat off the central axis C, and even in that case, the inlet cryopanel 32 can be regarded as being disposed at the central portion of the intake port 12. The inlet cryopanel 32 is disposed perpendicular to the central axis C. Further, with respect to the axial direction, the inlet cryopanel 32 may be disposed slightly above the shield front end 36.

Alternatively, the inlet cryopanel 32 may be disposed at substantially the same height as the shield front end 36 in the axial direction, or slightly below the shield front end 36 in the axial direction.

The second-stage cryopanel assembly 20 is provided at the central portion of the internal space 14 of the cryopump 10. The second-stage cryopanel assembly 20 includes an upper structure 20a and a lower structure 20b. The second-stage cryopanel assembly 20 includes a plurality of adsorption cryopanels 60 arranged in the axial direction. The plurality of adsorption cryopanels 60 are arranged at intervals in the axial direction.

The upper structure 20a of the second-stage cryopanel assembly 20 includes a plurality of upper cryopanels 60a and a plurality of heat transfer bodies (also referred to as heat transfer spacers) 62. The plurality of upper cryopanels 60a are disposed between the inlet cryopanel 32 and the second cooling stage 24 in the axial direction. The plurality of heat transfer bodies 62 are arranged in a columnar shape in the axial direction. The plurality of upper cryopanels 60a and the plurality of heat transfer bodies 62 are alternately stacked in the axial direction between the intake port 12 and the second cooling stage 24. The centers of the upper cryopanel 60a and the heat transfer body 62 are located together on the central axis C. In this way, the upper structure 20a is disposed above the second cooling stage 24 in the axial direction. The upper structure 20a is fixed to the second cooling stage 24 through a heat transfer block 63 formed of a high heat conductive metal material such as copper (for example, pure copper), and is thermally coupled to the second cooling stage 24. Therefore, the upper structure 20a is cooled to the second cooling temperature.

The lower structure 20b of the second-stage cryopanel assembly 20 includes a plurality of lower cryopanels 60b and a second-stage cryopanel mounting member 64. The plurality of lower cryopanels 60b are disposed between the second cooling stage 24 and the shield bottom portion 38 in the axial direction. The second-stage cryopanel mounting member 64 extends downward in the axial direction from the second cooling stage 24. The plurality of lower cryopanels 60b are mounted to the second cooling stage 24 through the second-stage cryopanel mounting members 64. In this way, the lower structure 20b is thermally coupled to the second cooling stage 24 and is cooled to the second cooling temperature.

In the second-stage cryopanel assembly 20, an adsorption area 66 is formed on at least a part of the surface. The adsorption area 66 is provided, for capturing a non-condensable gas (for example, hydrogen) by adsorption. The adsorption area 66 is formed, for example, by bonding an adsorbent (for example, activated carbon) to the surface of the cryopanel.

At least one of the plurality of adsorption cryopanels 60 (for example, each of the plurality of upper cryopanels 60a and/or at least one of the plurality of lower cryopanels 60b) includes an exposed area 68 and a non-exposed area 69. With respect to a certain cryopanel, the exposed area 68 refers to the place on the cryopanel that a gas to be pumped can linearly reach through the intake port 12, and the non-exposed area 69 refers to the place on the cryopanel that the gas to be pumped cannot linearly reach through the intake port 12. Therefore, the front surface of the cryopanel, which faces the intake port 12, can be divided into the exposed area 68 and the non-exposed area 69. The back surface of the cryopanel, which faces the side opposite to the intake port 12, that is, the shield bottom portion 38, becomes the non-exposed area 69.

The boundary between the exposed area 68 and the non-exposed area 69 on the front surface of a certain cryopanel may be determined in consideration of a line of sight which is directed from the inner peripheral edge of the shield front end 36 (which may be the inner peripheral edge of an intake port flange 72) to the outer peripheral edge of the cryopanel directly above the cryopanel. When the line of sight is extended, the line of sight forms an intersection on the front surface of the cryopanel. When the line of sight is scanned over the entire circumference of the shield front end 36, the intersection draws a locus on the front surface of the cryopanel. The area inside the locus is behind the cryopanel directly above and is not visible from the outside of the cryopump 10 through the intake port 12. The area outside the locus is visible from the outside of the cryopump 10 through the intake port 12. In this manner, the boundary between the exposed area 68 and the non-exposed area 69 can be determined by using the line of sight.

As an example, in FIG. 1, a first line of sight 74a and a second line of sight 74b are shown with broken lines. The first line of sight 74a is drawn from the shield front end 36 to the outer peripheral edge of the second upper cryopanel 60a from below and intersects the lowermost upper cryopanel 60a. Therefore, on the front surface of the lowermost upper cryopanel 60a, the area radially outside the first line of sight 74a becomes the exposed area 68, and the area radially inside the first line of sight 74a becomes the non-exposed area 69. The second line of sight 74b is drawn from the shield front end 36 to the outer peripheral edge of the lowermost upper cryopanel 60a and intersects the uppermost lower cryopanel 60b. Therefore, on the front surface of the uppermost lower cryopanel 60b, the area radially outside the second line of sight 74b becomes the exposed area 68, and the area radially inside the second line of sight 74b becomes the non-exposed area 69.

As an example, one or a plurality of upper cryopanels 60a that are closest to the inlet cryopanel 32 in the axial direction, among the plurality of upper cryopanels 60a, are flat plates (for example, disk-shaped) and are disposed perpendicular to the central axis C. The remaining upper cryopanels 60a have an inverted truncated cone shape, and a circular bottom surface is disposed perpendicular to the central axis C.

The upper cryopanel 60a closest to the inlet cryopanel 32 (that is, the upper cryopanel 60a located directly below the inlet cryopanel 32 in the axial direction, also referred to as a top cryopanel 61), among the upper cryopanels 60a, has a diameter larger than that of the inlet cryopanel 32. However, the diameter of the top cryopanel 61 may be equal to or smaller than the diameter of the inlet cryopanel 32. The top cryopanel 61 directly faces the inlet cryopanel 32, and no other cryopanel exists between the top cryopanel 61 and the inlet cryopanel 32.

The diameters of the plurality of upper cryopanels 60a gradually increase toward the lower side in the axial direction. Further, the inverted truncated cone-shaped upper cryopanel 60a is disposed in a nested manner. The lower part of the upper cryopanel 60a on the higher side enters the inverted truncated conical space in the upper cryopanel 60a adjacent thereunder.

Each heat transfer body 62 has a columnar shape. The heat transfer body 62 may have a relatively short columnar shape and may have an axial height smaller than the diameter of the heat transfer body 62. The cryopanel such as the adsorption cryopanel 60 is generally formed of a high heat conductive metal material such as copper (for example, pure copper), and as necessary, the surface thereof is coated with a metal layer such as nickel. In contrast, the heat transfer body 62 may be formed of a material different from that of the cryopanel. The heat transfer body 62 may be formed of a metal material, such as aluminum or an aluminum alloy, for example, having a lower density although it has a lower thermal conductivity than the adsorption cryopanel 60. In this way, both the thermal conductivity and the reduction in weight of the heat transfer body 62 can be achieved to some extent, which is helpful to reduce the cooling time of the second-stage cryopanel assembly 20.

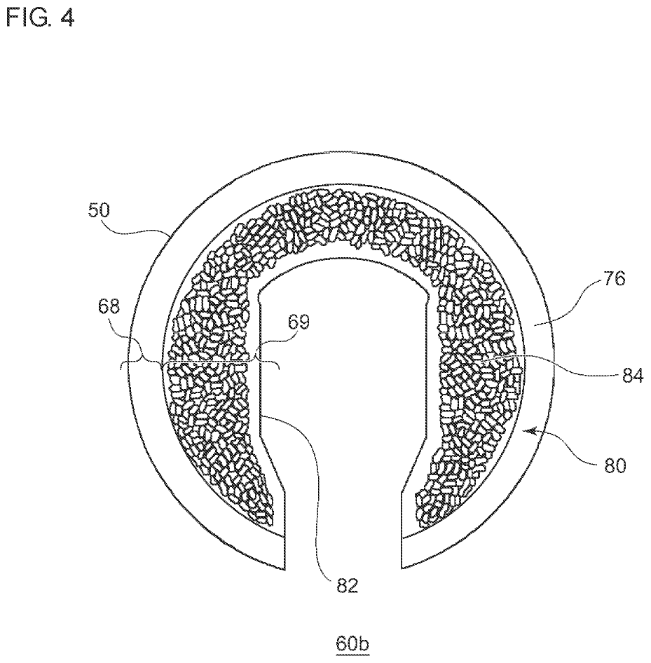

The lower cryopanel 60b is a flat plate, for example, in a disk shape. The lower cryopanel 60b has a larger diameter than the upper cryopanel 60a. However, a cutout portion (for example, a cutout portion 82 shown in FIG. 4) extending from a portion of the outer periphery to the central portion may be formed in the lower cryopanel 60b for mounting the lower cryopanel 60b to the second-stage cryopanel mounting member 64.

The specific configuration of the second-stage cryopanel assembly 20 is not limited to the configuration described above. The upper structure 20a may have any number of upper cryopanels 60a. The upper cryopanel 60a may have a flat plate shape, a conical shape, or other shapes. Similarly, the lower structure 20b may have any number of lower cryopanels 60b. The lower cryopanel 60b may have a flat plate shape, a conical shape, or other shapes.

The adsorption area 66 may be formed in a place that is hidden behind the adsorption cryopanel 60 adjacent to the upper side so as not to be seen from the intake port 12. That is, the adsorption area 66 is disposed in the non-exposed area 69. For example, the adsorption area 66 is formed on the entire lower surface of the adsorption cryopanel 60. The adsorption area 66 may be formed on the upper surface of the lower cryopanel 60b. Further, although not shown in FIG. 1 for the sake of simplification, the adsorption area 66 is also formed on the lower surface (back surface) of the upper cryopanel 60a. As necessary, the adsorption area 66 may be formed on the upper surface of the upper cryopanel 60a.

In the adsorption area 66, a large number of activated carbon particles are bonded in an irregular arrangement in a state of being densely arranged on the surface of the adsorption cryopanel 60. The activated carbon particles are molded, for example, in a columnar shape. The shape of the adsorbent may not be a columnar shape and may be, for example, a spherical shape, another molded shape, or an irregular shape. The arrangement of the adsorbents on the panel may be a regular arrangement or an irregular arrangement.

Further, a condensation area for capturing a condensable gas by condensation is formed on at least a part of the surface of the second-stage cryopanel assembly 20. The exposed area 68 can serve as a condensation area. The condensation area is, for example, a section where the adsorbent is missing on the surface of the cryopanel, and the surface of the cryopanel base material, for example, the metal surface is exposed. The upper surface, the outer peripheral portion of the upper surface, or the outer peripheral portion of the lower surface of the adsorption cryopanel 60 (for example, the upper cryopanel 60a) may be a condensation area.

Both the upper and lower surfaces of the top cryopanel 61 may be condensation areas. That is, the top cryopanel 61 may not have the adsorption area 66. In this manner, in the second-stage cryopanel assembly 20, the cryopanel which does not have the adsorption area 66 may be referred to as a condensation cryopanel. For example, the upper structure 20a may be provided with at least one condensation cryopanel (for example, the top cryopanel 61).

The cryopump housing 70 is a casing of the cryopump 10, which accommodates the first-stage cryopanel 18, the second-stage cryopanel assembly 20, and the cryocooler 16, and is a vacuum container configured to maintain the vacuum tightness of the internal space 14. The cryopump housing 70 includes the first-stage cryopanel 18 and the cryocooler structure part 21 in a non-contact manner. The cryopump housing 70 is mounted to the room temperature part 26 of the cryocooler 16.

The intake port 12 is defined by a front end of the cryopump housing 70. The cryopump housing 70 has the intake port flange 72 extending radially outward from the front end thereof. The intake port flange 72 is provided over the entire circumference of the cryopump housing 70. The cryopump 10 is mounted to the vacuum chamber to be evacuated by using the intake port flange 72.

As described above, the second-stage cryopanel assembly 20 has a large number of adsorption cryopanels 60 (that is, the plurality of upper cryopanels 60a and lower cryopanels 60b), and therefore, it has high pumping performance for a non-condensable gas. For example, the second-stage cryopanel assembly 20 can pump hydrogen gas at a high pumping speed.

Each of the plurality of adsorption cryopanels 60 includes the adsorption area 66 at a portion which is not visible from the outside from the cryopump 10. Therefore, the second-stage cryopanel assembly 20 is configured such that all or most of the adsorption areas 66 are completely invisible from the outside of the cryopump 10. The cryopump 10 can also be called an adsorbent non-exposure type cryopump.

Incidentally, the gas accumulated in the cryopump is usually discharged substantially completely by regeneration treatment, and when the regeneration is completed, the cryopump is restored to the pumping performance in the specification. However, in an adsorbent exposure type cryopump in which the adsorbent is disposed so as to be visible from the outside of the cryopump, the percentage of components of the accumulated gas, which remain in the adsorbent even after the regeneration treatment, is relatively high.

For example, in a cryopump installed for evacuation of an ion implanter, it was observed that a sticky substance adheres to activated carbon as an adsorbent. It was difficult to completely remove the sticky substance even after regeneration treatment. It is considered that the sticky substance is caused by an organic outgas which is discharged from photoresist coated on a substrate to be treated. Alternatively, there is also a possibility that it may be caused by a dopant gas, that is, a toxic gas which is used as a raw material gas in ion implantation treatment. A possibility that it may be caused by other by-produced gases in the ion implantation treatment is also considered. There is also a possibility that these gases may be related to each other in a complex manner to form a sticky substance.

In the ion implantation treatment, most of the gases which are pumped by the cryopump can be hydrogen gas. Hydrogen gas is discharged substantially completely to the outside by regeneration. When the amount of poorly regenerated gas is very small, the influence of the poorly regenerated gas on the pumping performance of the cryopump in single cryopumping treatment is minor. However, in the adsorbent exposure type cryopump, the poorly regenerated gas may be gradually accumulated on the adsorbent as the cryopumping treatment and the regeneration treatment are repeated, and thus there is a possibility that the pumping performance may be reduced. When the pumping performance falls below an allowable range, maintenance work including, for example, replacement of the adsorbent or the cryopanel together with it, or chemical removal treatment of the poorly regenerated gas on the adsorbent is required.

The poorly regenerated gas is a condensable gas almost without exception. The molecules of the condensable gas which comes flying from the outside toward the cryopump 10 pass through an open area around the inlet cryopanel 32, then reach the condensation area on the outer periphery of the radiation shield 30 or the second-stage cryopanel assembly 20 in a linear path, and are captured on the surface thereof. The poorly regenerated gas is deposited on the condensation area. As described above, since the cryopump 10 is an adsorbent non-exposure type and the adsorption area 66 is disposed in the non-exposed area 69, the adsorption area 66 is protected from the poorly regenerated gas.

On the other hand, the exposed area 68 can be contaminated with the poorly regenerated gas. The contaminated adsorption cryopanel 60 may need to be disassembled from the cryopump 10 and washed during the maintenance of the cryopump 10. Since the adsorbent such as activated carbon provided in the adsorption area 66 is not contaminated with the poorly regenerated gas, it is considered that it can be reused. The washed cryopanel is reassembled and used in a case where it is reusable. However, depending on a washing method, the adsorption function of the adsorption area 66 may be lost. In that case, the adsorption cryopanel 60 after washing cannot be reused, and therefore, it has to be discarded.

Therefore, the exposed area 68 is covered with a removable protective surface 76. The removable protective surface 76 is provided in the exposed area 68 of at least one adsorption cryopanel 60. The removable protective surface 76 may be provided on each of the plurality of adsorption cryopanels 60. The removable protective surface 76 may have various exemplary configurations, which will be described below.

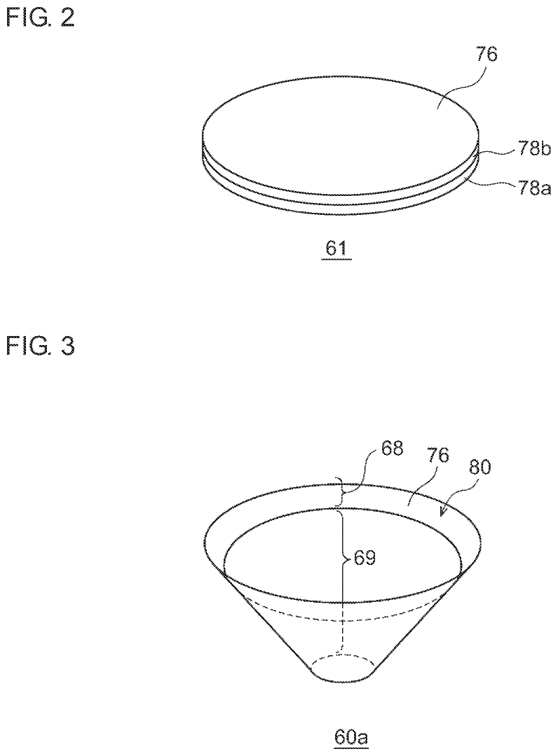

FIG. 2 is a schematic perspective view of an exemplary cryopanel that can be used in the cryopump 10 shown in FIG. 1. The cryopanel shown in the drawing is a cryopanel that can be used in the second-stage cryopanel assembly 20, and is the top cryopanel 61. However, the cryopanel shown in the drawing may be another adsorption cryopanel 60 which is used in the second-stage cryopanel assembly 20.

The top cryopanel 61 includes a first cryopanel base material 78a and a second cryopanel base material 78b. The cryopanel base materials 78a and 78b are formed of the same material (for example, a metal material) and have the same shape. The cryopanel base materials 78a and 78b are formed of, for example, a high heat conductive metal material such as copper (for example, pure copper), and as necessary, the surface is coated with a metal layer such as nickel. Therefore, the cryopanel base materials 78a and 78b themselves cannot adsorb the non-condensable gas. Although not shown in the drawing, in order to make the top cryopanel 61 be capable of adsorbing the non-condensable gas, the first cryopanel base material 78a may have an adsorbent provided on the back surface (lower surface) thereof. Alternatively, the first cryopanel base material 78a may not be provided with an adsorbent, and in that case, the top cryopanel 61 does not adsorb the non-condensable gas. The cryopanel base materials 78a and 78b have, for example, a disk shape. The cryopanel base materials 78a and 78b may have a conical shape or other shapes.

The second cryopanel base material 78b is removably mounted on the first cryopanel base material 78a so as to provide the removable protective surface 76. The second cryopanel base material 78b is removably mounted on the first cryopanel base material 78a such that the back surface thereof is in contact with the front surface of the first cryopanel base material 78a and covers the entire front surface of the first cryopanel base material 78a. The front surface of the second cryopanel base material 78b is used as the protective surface 76.

Further, the second cryopanel base material 78b is thermally coupled to the first cryopanel base material 78a and is cooled together with the first cryopanel base material 78a. The second cryopanel base material 78b is mounted on the first cryopanel base material 78a by an appropriate removable mounting method such as a removable fastening member such as a bolt or a peelable adhesive such that there is good thermal contact between the cryopanel base materials 78a and 78b.

The first cryopanel base material 78a corresponds to a cryopanel that is typically used. In the embodiment shown in FIG. 2, the second cryopanel base material 78b is superimposed on the first cryopanel base material 78a. The second cryopanel base material 78b added in this way provides the removable protective surface 76.

The second cryopanel base material 78b does not have an adsorption area, that is, an adsorbent, because it is made be unable to adsorb a non-condensable gas. Therefore, in the manufacturing process, a process of attaching an adsorbent to the cryopanel base material is not required. On the other hand, the adsorption cryopanel 60 which requires such an adsorbent attachment process is costly to manufacture. Therefore, the second cryopanel base material 78b can be provided at a relatively low cost.

Further, since the second cryopanel base material 78b is designed to be equivalent to the first cryopanel base material 78a which is typically used for the cryopanel, the thermal performance, mechanical strength, and other necessary conditions which are required for use in the cryopump 10 are satisfied. Therefore, the second cryopanel base material 78b can be easily used by a designer of the cryopump 10.

Since the second cryopanel base material 78b is cooled to the second cooling temperature in the same manner as the first cryopanel base material 78a, the poorly regenerated gas condenses on the protective surface 76 on the second cryopanel base material 78b and can contaminate the protective surface 76. However, with respect to the first cryopanel base material 78a, contamination is prevented or mitigated by the protective surface 76. In a case where there is no contamination or the degree of contamination is light, it is possible to reuse the top cryopanel 61 without performing complicated work such as disassembling or washing during the maintenance of the cryopump 10. Since the second cryopanel base material 78b does not have an adsorbent, it can be reused if it is washed. Alternatively, as described above, since the second cryopanel base material 78b is relatively inexpensive, even if the used cryopanel base material 78b is discarded and replaced with a new cryopanel base material 78b, the influence in terms of a cost is small.

After the used cryopanel base material 78b is removed, a new cryopanel base material 78b may not be mounted on the first cryopanel base material 78a. In this case, since the protective surface 76 is not provided on the first cryopanel base material 78a, the front surface of the first cryopanel base material 78a may be contaminated during the subsequent operation of the cryopump 10. The first cryopanel base material 78a may have to be replaced with a new first cryopanel base material at the next maintenance. However, since the adsorbent on the first cryopanel base material 78a also has a limited life, it is eventually necessary to replace the first cryopanel base material 78a together with the adsorbent regardless of the presence or absence of contamination of the first cryopanel base material 78a. Therefore, whether or not to mount a new cryopanel base material 78b may be determined in consideration of the cost of the cryopanel base material 78b or the life of the adsorbent.

FIG. 3 is a schematic perspective view of another exemplary cryopanel that can be used in the cryopump 10 shown in FIG. 1. The cryopanel shown in the drawing is a cryopanel that can be used in the second-stage cryopanel assembly 20, and is the upper cryopanel 60a. However, the cryopanel shown in the drawing may be another adsorption cryopanel 60 which is used in the second-stage cryopanel assembly 20.

The upper cryopanel 60a has, for example, an inverted conical shape, as described with reference to FIG. 1. The front surface of the upper cryopanel 60a has the exposed area 68 at the outer peripheral portion and has the non-exposed area 69 inside the exposed area 68. An adsorbent may be provided in the non-exposed area 69. However, for the sake of simplification of the illustration, the illustration thereof is omitted in FIG. 3.

The upper cryopanel 60a (or the adsorption cryopanel 60) includes a protective layer 80 that covers the exposed area 68 so as to provide the removable protective surface 76. The non-exposed area 69 is not provided with the protective layer 80. The surface of the protective layer 80 that functions as the protective surface 76 may be formed of a material having corrosion resistance against the poorly regenerated gas, for example, fluororesin such as polytetrafluoroethylene or another resin, or metal such as aluminum or copper. Accordingly, the protective layer 80 may be an adhesive tape having a surface made of such a synthetic resin material or metal material, or a peelably bonded protective film. The protective layer 80 is bonded to the cryopanel base material of the upper cryopanel 60a, thereby being thermally coupled thereto and cooled to the same cooling temperature.

Since the protective layer 80 is installed in the exposed area 68 and cooled to the second cooling temperature, the poorly regenerated gas condenses on the protective surface 76 and can contaminate the protective surface 76. Since the protective layer 80 is peelably bonded to the upper cryopanel 60a, it is possible to remove contaminants from the upper cryopanel 60a by peeling off the protective layer 80 during the maintenance of the cryopump 10. The upper cryopanel 60a can be reused without performing complicated work such as disassembly or washing during the maintenance.

FIG. 4 is a schematic top view of still another exemplary cryopanel that can be used in the cryopump 10 shown in FIG. 1. The cryopanel shown in the drawing is a cryopanel that can be used in the second-stage cryopanel assembly 20, and is the lower cryopanel 60b. However, the cryopanel shown in the drawing may be another adsorption cryopanel 60 which is used in the second-stage cryopanel assembly 20.

The lower cryopanel 60b has, for example, a disk-like shape, as described with reference to FIG. 1. However, the cutout portion 82 extending from a portion of the outer periphery to the center portion is formed in the lower cryopanel 60b for mounting of the lower cryopanel 60b to the second-stage cryopanel mounting member 64. The front surface of the lower cryopanel 60b has the exposed area 68 at the outer peripheral portion and has the non-exposed area 69 inside the exposed area 68. Granular activated carbon 84 as an adsorbent is attached to the non-exposed area 69.

The lower cryopanel 60b (or the adsorption cryopanel 60) includes the protective layer 80 made of synthetic resin or metal and peelably bonded to the exposed area 68 so as to provide the removable protective surface 76. The protective layer 80 is bonded to the cryopanel base material of the lower cryopanel 60b, thereby being thermally coupled thereto and cooled to the same cooling temperature.

Since the protective layer 80 is installed in the exposed area 68 and cooled to the second cooling temperature, the poorly regenerated gas condenses on the protective surface 76 and can contaminate the protective surface 76. Since the protective layer 80 is peelably bonded to the lower cryopanel 60b, it is possible to remove contaminants from the lower cryopanel 60b by peeling off the protective layer 80 during the maintenance of the cryopump 10. The lower cryopanel 60b can be reused without performing complicated work such as disassembly or washing during the maintenance.

After the used protective layer 80 is peeled off, a new protective layer 80 may or may not be attached to the adsorption cryopanel 60. Whether or not to attach the new protective layer 80 may be determined in consideration of the cost of the protective layer 80 or the life of the adsorbent on the adsorption cryopanel 60.

Alternatively, a plurality of protective layers 80 may be layered on the exposed area 68. In this way, when the used protective layer 80 is peeled off, a new protective layer 80 directly below it is exposed and can be used.

The operation of the cryopump 10 having the above configuration will be described below. When the cryopump 10 is operated, first, the interior of the vacuum chamber is roughed to about 1 Pa with another appropriate roughing pump before the operation. Thereafter, the cryopump 10 is operated. The first cooling stage 22 and the second cooling stage 24 are respectively cooled to the first cooling temperature and the second cooling temperature by the driving of the cryocooler 16. Accordingly, the first-stage cryopanel 18 and the second-stage cryopanel assembly 20 thermally coupled to these are also respectively cooled to the first cooling temperature and the second cooling temperature.

The inlet cryopanel 32 cools the gas which comes flying from the vacuum chamber toward the cryopump 10. A gas having a sufficiently low vapor pressure (for example, 10⁻⁸ Pa or less) at the first cooling temperature condenses on the surface of the inlet cryopanel 32. This gas may be referred to as a type-1 gas. The type-1 gas is, for example, water vapor. In this way, the inlet cryopanel 32 can pump the type-1 gas. A part of a gas in which vapor pressure is not sufficiently low at the first cooling temperature enters the internal space 14 from the intake port 12. Alternatively, the other part of the gas is reflected by the inlet cryopanel 32 and does not enter the internal space 14.

The gas that has entered the internal space 14 is cooled by the second-stage cryopanel assembly 20. A gas having a sufficiently low vapor pressure (for example, 10⁻⁸ Pa or less) at the second cooling temperature condenses on the surface of the condensation area of the adsorption cryopanel 60. This gas may be referred to as a type-2 gas. The type-2 gas is, for example, nitrogen (N₂) or argon (Ar). In this way, the second-stage cryopanel assembly 20 can pump the type-2 gas.

A gas in which vapor pressure is not sufficiently low at the second cooling temperature is adsorbed by the adsorption area 66 of the adsorption cryopanel 60. This gas may be referred to as a type-3 gas. The type-3 gas is, for example, hydrogen (H₂). In this way, the second-stage cryopanel assembly 20 can pump the type-3 gas. Therefore, the cryopump 10 can pump various gases by condensation or adsorption and can make the degree of vacuum of the vacuum chamber reach a desired level.

According to the cryopump 10 according to the embodiment, the exposed area 68 is covered with the removable protective surface 76. Since it is cooled to the second cooling temperature in the same manner as the second-stage cryopanel assembly 20, the poorly regenerated gas is condensed on the protective surface 76. The poorly regenerated gas can adhere to the protective surface 76 to contaminate it. However, the protective surface 76 can be removed. The protective surface 76 is removed, whereby the clean surface which has been covered with the protective surface 76 is exposed. Alternatively, the exposed area 68 is protected again by attaching a new protective surface 76. Therefore, the cryopump 10 does not need to disassemble and wash the second-stage cryopanel assembly 20 in order to remove deposits such as the poorly regenerated gas during the maintenance. The maintenance of the cryopump 10 can be easily performed as compared with a cryopump which is not provided with such a removable protective surface 76.

In particular, as described above, since the cryopump 10 is an adsorbent non-exposure type and the adsorption area 66 is disposed in the non-exposed area 69, the adsorption area 66 is protected from the poorly regenerated gas. Therefore, in a case where the poorly regenerated gas is removed by removing or replacing the protective surface 76, the second-stage cryopanel assembly 20 can be reused. In this manner, in a case where the cryopump 10 is an adsorbent non-exposure type, in particular, the maintenance of the cryopump 10 can be easily performed.

The present invention has been described above based on the examples. It will be understood by those skilled in the art that the present invention is not limited to the embodiments described above, various design changes can be made, various modification examples can be made, and such modification examples are also within the scope of the present invention.

In the embodiments described above, the case where the protective layer 80 is not provided in the non-exposed area 69 has been described as an example. However, this is not essential to the present invention. In a certain embodiment, at least a part of the non-exposed area 69 (for example, the portion outside the adsorption area 66 in the non-exposed area 69) may be covered with the removable protective surface 76. For example, in the non-exposed area 69, the protective layer 80 may be peelably bonded to an area to which an adsorbent such as activated carbon is not attached.

In the above description, the horizontal cryopump has been exemplified. However, the present invention is also applicable to other vertical cryopumps. The vertical cryopump refers to a cryopump in which the cryocooler 16 is disposed along the central axis C of the cryopump 10. Further, the internal configuration of the cryopump, such as the arrangement, the shape, the number, or the like of a cryopanel, is not limited to the specific embodiment described above. Various known configurations can be appropriately adopted.

The present invention can be used in the field of cryopumps and cryopanels.

It should be understood that the invention is not limited to the above-described embodiment, but may be modified into various forms on the basis of the spirit of the invention. Additionally, the modifications are included in the scope of the invention.

What is claimed is:

1. A cryopump comprising:
a cryopanel assembly which includes an exposed area that a gas to be pumped can linearly reach through a cryopump intake port and a non-exposed area that the gas to be pumped cannot linearly reach through the cryopump intake port,
wherein the non-exposed area has an adsorption area capable of adsorbing a non-condensable gas, and the exposed area is covered with a removable protective surface.

2. The cryopump according to claim 1, further comprising:
a protective layer made of resin or metal and peelably bonded to the exposed area so as to act as the removable protective surface.

3. The cryopump according to claim 1, wherein a plurality of protective layers is layered on the exposed area.

4. The cryopump according to claim 1, wherein the cryopanel assembly includes a first cryopanel base material that is incapable of adsorbing the non-condensable gas, and a second cryopanel base material that is incapable of adsorbing the non-condensable gas, and
the second cryopanel base material is removably mounted on the first cryopanel base material so as to act as the removable protective surface.

5. The cryopump according to claim 1, wherein at least a part of the non-exposed area is covered with the removable protective surface.

6. The cryopump according to claim 1, further comprising:
a radiation shield axially extending from the cryopump intake port in a substantially tubular shape so as to surround the cryopanel assembly; and
a cryocooler that includes a high-temperature cooling stage for cooling the radiation shield and a low-temperature cooling stage for cooling the cryopanel assembly, in which the low-temperature cooling stage is cooled to a lower temperature than the high-temperature cooling stage.

7. The cryopump according to claim 6, wherein the cryopanel assembly includes a plurality of cryopanels, each including the exposed area and the non-exposed area, and a plurality of heat transfer bodies axially arranged to form a substantially columnar shape, wherein the plurality of cryopanels and the plurality of heat transfer bodies are axially stacked.

8. The cryopump according to claim 6, wherein the cryopanel assembly includes a top cryopanel disposed axially topmost of the cryopanel assembly,
the top cryopanel includes a first cryopanel base material and a second cryopanel base material that acts as the removable protective surface, and
the second cryopanel base material is removably mounted on the first cryopanel base material such that a back surface thereof is in contact with a front surface of the first cryopanel base material and entirely covers the front surface of the first cryopanel base material.

9. The cryopump according to claim 6, wherein the cryopanel assembly includes at least one upper cryopanel disposed axially above the low-temperature cooling stage and having a substantially inverted conical outer peripheral portion, and
the exposed area covered with the removable protective surface constitutes the substantially inverted conical outer peripheral portion.

10. The cryopump according to claim 6, wherein the cryopanel assembly includes at least one lower cryopanel disposed axially below the low-temperature cooling stage, and
the exposed area covered with the removable protective surface constitutes an outer peripheral portion of the at least one lower cryopanel.

11. A cryopanel comprising
a cryopanel base material; and
a removable protective surface that covers at least a part of the cryopanel base material.
